(19) United States
(12) Patent Application Publication
(10) Pub. No.: US 2006/0126516 A1
(43) Pub. Date: Jun. 15, 2006

(54) Network device signaling characteristic adjustment based on presence of an attachment

(76) Inventors: Kent Lusted, Aloha, OR (US); Amir Mezer, Haifa (IL)

Correspondence Address: BUCKLEY, MASCHOFF, TALWALKAR LLC, 5 ELM STREET, NEW CANAAN, CT, 06840, US

(21) Appl. No.: 11/012,673

(22) Filed: Dec. 15, 2004

(51) Int. Cl. H04J 1/16; H04J 3/22; H04J 3/16; H04L 12/26

(52) U.S. Cl. 370/241; 370/465

(57) ABSTRACT

According to some embodiments, a first measurement of a network device signaling characteristic is performed. The network device includes a first communication port and a second communication port, the second port being associated with a detachable attachment. The first measurement is performed when the attachment is not attached to the second port. A second measurement of the signaling characteristic is then performed when the attachment is attached to the second port. At least one corrective value to be used by the network device is then determined based on the first and second measurement.

### BACKGROUND

A network device may exchange information through a network. In some cases, the network device might exchange information through the network via more than one communication port. For example, a mobile computer might exchange information through a first port when it is not connected to a docking station and through a second port when it is connected to a docking station.

Note that one or more signaling characteristics of a network device may need to comply with an industry standard so that the device will be able to communicate with other devices. The presence of an attachment, however, might change the signaling characteristics of the network device. For example, a signaling characteristic of a mobile computer might change when it is attached to a docking station as compared to when it is not attached to the docking station. To ensure that the device complies with a standard in both situations, a system designer might modify a circuit board design by adding inductive components, capacitive components, and/or active transistor elements. Such an approach can be time consuming and increase the cost and complexity of the network device.

### BRIEF DESCRIPTION OF THE DRAWINGS

FIG. 1 is a block diagram of a network device according to some embodiments.

FIG. 2 is a graph illustrating a network signal characteristic of the network device.

FIG. 3 is a flow diagram illustrating a method according to some embodiments.

FIG. 4 is a graph illustrating a network signal characteristic of the network device according to some embodiments.

FIG. 5 is a block diagram of a system according to some embodiments.

FIG. 6 is a flow diagram illustrating a system design method according to some embodiments.

FIG. 7 is a flow diagram illustrating a network device method according to some embodiments.

FIG. 8 is a block diagram of a system according to some embodiments.

### DETAILED DESCRIPTION

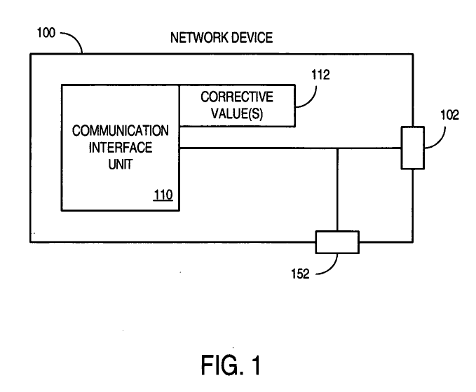

FIG. 1 is a block diagram of a network device 100 according to some embodiments. As used herein, the phrase “network device” may refer to any device that is able to exchange information via a network. The network device 100 might be, for example, a mobile computer, a laptop computer, a hand-held computer, a Personal Digital Assistant (PDA), a game device, a media player, or a Personal Computer (PC).

The network device 100 includes a communication interface unit 110 to facilitate an exchange of information through a network. The communication interface unit 110 might be, for example, an Ethernet controller adapted to exchange information in accordance with the Institute of Electrical and Electronics Engineers standard number 802.3 entitled “Carrier Sense Multiple Access with Collision Detection (CSMA/CD) Access Method and Physical Layer Specifications” (2002).

The network device 100 is adapted to exchange information through the network via more than one communication port. In particular, the network device 100 includes a first communication port 102 through which the communication interface unit 110 can exchange information.

Moreover, the network device 100 includes a second communication port 152 associated with a detachable attachment (not illustrated in FIG. 1) through which the communication interface unit 110 can exchange information. For example, the network device 100 might either (i) exchange information with a network via a removable docking station when such a station is attached to the second port 152 or (ii) exchange information directly with the network via the first port 102 when a docking station is not attached. As used herein, the term “docking station” may refer to any apparatus adapted to exchange information between the network device 100 and another device (e.g., a cradle).

Note that one or more signaling characteristics of the network device 100 may need to comply with an industry guideline or standard so that the device will be able to communicate with other devices. For example, the network device 100 may need to generate output waveforms in compliance with IEEE 802.3 section 40.6.1.3 entitled “Differential Output Templates.”

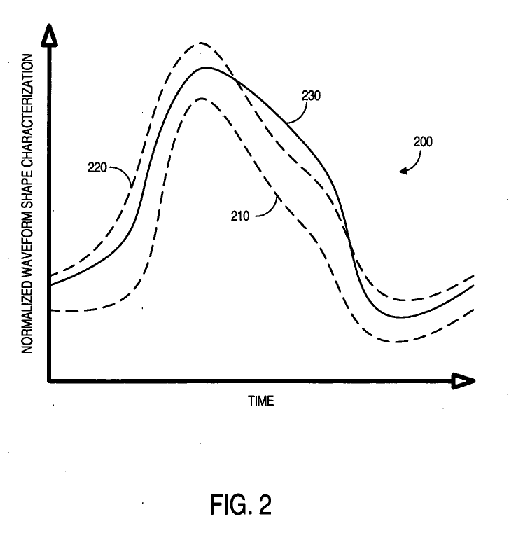

In some cases, however, the presence of an attachment might influence the signaling characteristics of the network device 100 (e.g., a signaling characteristic might change when a docking station is attached). For example, FIG. 2 is a graph 200 illustrating a network signal characteristic of the network device 100 when the attachment coupled to the second port 152. In particular, the graph 200 shows a lower normalized waveform shape characterization threshold 210 and an upper threshold 220 between which an actual output 230 of the network device 100 must remain over time in order to comply with a standard. As can be seen, the network device 100 does not comply with the standard when the attachment is present (because the output 230 rises above the upper threshold 220).

To ensure that the network device 100 complies with the standard (both when the attachment is present and is not present), a system designer might modify a circuit board design by adding passive components, including but not limited to inductors or capacitors, and/or active transistor elements. Such an approach, however, can be time consuming and increase the cost of the network device 100.

According to some embodiments, the network device 100 further includes a storage unit 112 to store one or more corrective values. Moreover, the communication interface unit 110 is able to adjust a signaling characteristic in accordance with the corrective values. For example, the communication interface unit 110 might adjust an output waveform in accordance with a corrective value when an attachment is attached to the second port 152. Note that the storage unit 112 could be part of the communication interface unit 110 or external to the communication interface unit 110.

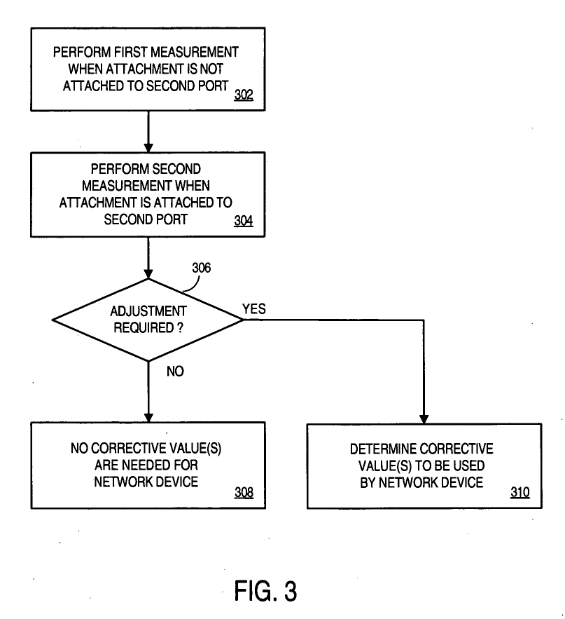

FIG. 3 is a flow diagram illustrating a method according to some embodiments. The method may have been performed, for example, by a system tester and/or designer when the network device 100 was being developed. The flow charts described herein do not necessarily imply a fixed order to the actions, and embodiments may be performed in any order that is practicable.

At 302, a first measurement of a signaling characteristic associated with the network device 100 is performed when the attachment is not attached to the second port 152. At 304, a second measurement of the signaling characteristic is performed when the attachment is attached to the second port 152.

If it is determined that no adjustment is required at 306 (e.g., because both measurements complied with a standard), then no corrective values are needed for the network device 100 at 308.

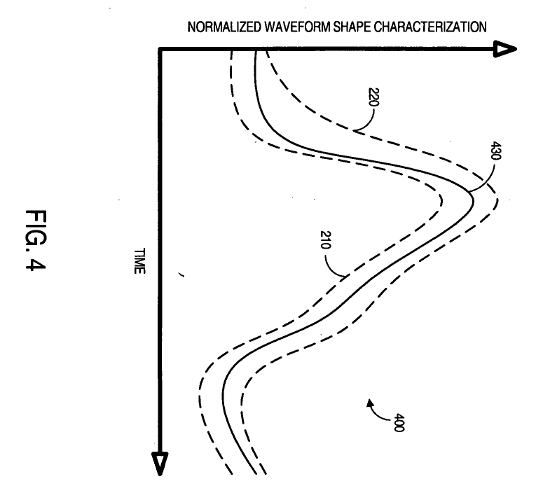

If it is determined that an adjustment is required at 306 (e.g., because one or both measurements did not comply with a standard), then one or more corrective values are determined for the network device 100 at 310. For example, if an output waveform rises above an upper threshold when an attachment is coupled to the network device 100, the corrective value might indicate that the communication interface unit 110 should reduce the output waveform when the attachment is detected. For example, FIG. 4 is a graph 400 illustrating a network signal characteristic 430 of the network device 100 when the attachment is present at the second port 152 and the corrective value(s) are being applied in accordance with some embodiments.

Note that the method of FIG. 3 might be repeated until an appropriate set of corrective values are determined for a particular design. Also note that once an appropriate set of corrective values are determined for a particular circuit board design and/or layout, the same set of values might be loaded for all products that are produced with that design.

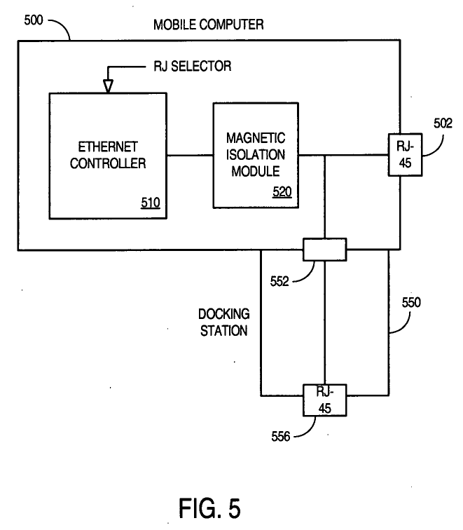

FIG. 5 is a block diagram of a system according to some embodiments. In particular, the system includes a mobile computer 500 that can be attached to a docking station 550. The mobile computer includes an Ethernet controller 510 having a silicon storage element that can be loaded with corrective values that may be applied to adjust an output waveform.

The mobile computer 500 exchanges information through an Ethernet Local Area Network (LAN) via a first port 502, such as an RJ-45 interface and associated stub, when the docking station 550 is not present.

When the docking station 550 is present, the mobile computer 500 exchanges information via a second communication port 552 and associated stub. The docking station 550 transfers information between this second port 552 and another RJ-45 interface 556. According to some embodiments, a magnetic isolation module 514 is provided between the Ethernet controller 510 and the first and second ports 502, 552. The magnetic isolation module 514 may, for example, isolate the silicon of the Ethernet controller 510 from the physical wire associated with the ports 502, 552.

According to some embodiments, the Ethernet controller 510 receives a signal (“RJ Selection”) indicating whether or not the docking station 550 is present. In this case, the Ethernet controller 510 can apply the locally stored corrective values to the output waveform as appropriate based on the received signal.

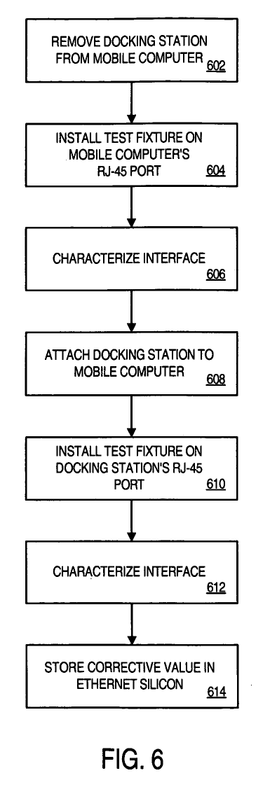

FIG. 6 is a flow diagram illustrating a system design method according to some embodiments. The method may have been performed, for example, by a system tester and/or designer while the mobile computer 500 was being designed.

At 602, the docking station 550 is removed from the mobile computer 500, and at 604 a test fixture is installed on the mobile computer's first port 502. The interface is then characterized at 606. That is, one or more signaling characteristics associated with the mobile computer 500 and/or Ethernet controller 510 may be measured and/or compared to a standard, guideline, or any other performance goal.

At 608, the docking station 550 is connected the mobile computer 500, and at 610 a test fixture is installed on the docking station's RJ-45 port 556. The interface is again characterized at 612. Based on the information collected during the two characterizations of the interface, at 614 one or more corrective values are stored at the Ethernet controller 510. For example, the Ethernet controller 510 might be given a set of corrective values to be applied when the docking station 550 is not present (or set of corrective values to be applied when the docking station 550 is present).

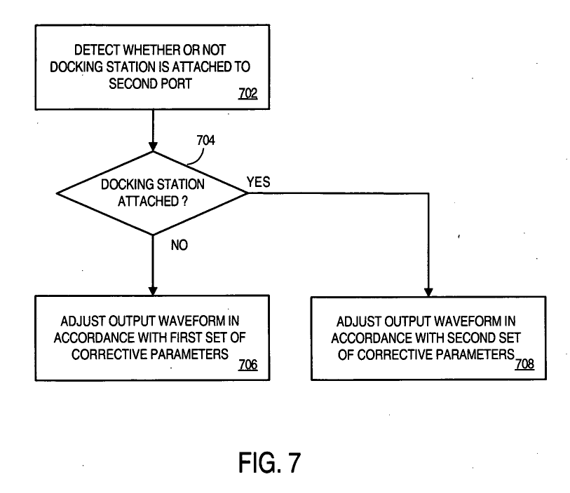

FIG. 7 is a flow diagram illustrating method that may be performed, for example, by the mobile computer 500 according to some embodiments. Note that any of the methods described herein may be performed by hardware, software (including microcode), firmware, or any combination of these approaches. For example, a storage medium may store thereon instructions that when executed by a machine result in performance according to any of the embodiments described herein.

At 702, it is determined whether or not the docking station 550 is currently attached to the second port 552. For example, the mobile computer 500 might receive a signal from the docking station 550 indicating that it is present. The determination might be made, for example, on a periodic basis or upon a change in the presence of the docking station 550.

If the docking station 550 is not currently attached at 704, the mobile computer 510 adjusts an output waveform in accordance with a first set of corrective parameters at 706. For example, Ethernet controller 510 might retrieve the first set of corrective parameters and adjust the amplitude and/or timing associated with the output signal as appropriate.

If the docking station 550 is currently attached at 704, the mobile computer 510 adjusts an output waveform in accordance with a second set of corrective parameters at 708. For example, Ethernet controller 510 might retrieve the second set of corrective parameters and adjust output signal as appropriate.

By using corrective values to adjust the output waveform based on the presence (or absence) of the docking station 550, an efficient way to compensate for various mobile computer 500 board designs may be provided for the Ethernet physical layer interface.

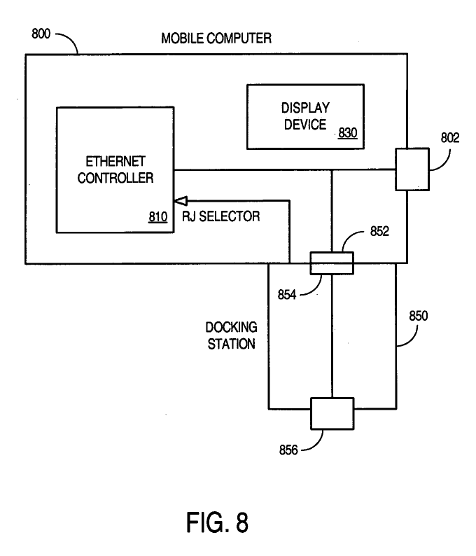

FIG. 8 is a block diagram of a system including a mobile computer 800 and a docking station 850 according to some embodiments. The mobile computer 800 includes an Ethernet controller 810 can exchange information via either a first port 802 or a second port 852. In particular, the Ethernet controller 810 will communicate through a LAN via the first port 802 when the docking station 550 is not attached.

The docking station 850 includes a first interface 854 adapted to be coupled to the second port 852 of the mobile computer 800. The first interface 854 is connected to a second interface 856 of the docking station 856. When the docking station 850 is attached to the mobile computer 800, the Ethernet controller 810 will communicate through the LAN via this second interface 856.

The Ethernet controller 810 may operate in accordance with any of the embodiments described herein. For example, the Ethernet controller 810 might include a storage unit to store a corrective value associated with a network device signaling characteristic. The Ethernet controller 810 might then adjust an output waveform based on the corrective value and the presence of the docking station 850. According to some embodiments, the mobile computer 800 further includes a color display device (e.g., a laptop's display screen).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described wherein a system tester or designer selects corrective values as appropriate, any of the embodiments described herein may be performed using an automated process. For example, a test device might select potential corrective values, characterize the interface, and adjust the potential corrective values until an appropriate set of corrective values are determined.

Moreover, although some embodiments have been described wherein the first measurement is performed when another device is attached and the second measurement is performed when the other device is not attached, any of these embodiments could be performed in the opposite order. In addition, although embodiments have been described with respect to network devices have two ports, embodiments can be used with any multiple number of ports.

The several embodiments described herein are solely for the purpose of illustration. Persons skilled in the art will recognize from this description other embodiments may be practiced with modifications and alterations limited only by the claims.

What is claimed is:

1. A method, comprising:
performing a first measurement of a network device signaling characteristic, the network device having a first communication port and a second communication port, the second port being associated with a detachable attachment, wherein said first measurement is performed when the attachment is not attached to the second port;
performing a second measurement of the signaling characteristic when the attachment is attached to the second port; and
determining, based on the first and second measurements, at least one corrective value to be used by the network device to adjust the signaling characteristic in accordance with the presence of the attachment.

2. The method of claim 1, wherein the first and second ports are both to facilitate communication via the same type of network.

3. The method of claim 1, wherein the signaling characteristic is associated with waveform shape characterization over time.

4. The method of claim 3, wherein the signaling characteristic is associated with compliance with the Institute of Electrical and Electronics Engineers 802.3 standard.

5. The method of claim 1, wherein performing the first measurement includes:
installing a test fixture to the first port when the attachment is not attached to the second communication port.

6. The method of claim 1, wherein performing the second measurement includes:
attaching the attachment to the second port, the attachment having a first interface associated with the second port and a second interface coupled to the first interface; and
installing a test fixture to the second interface of the attachment.

7. The method of claim 1, further comprising:
analyzing the first and second measurements to determine the corrective value.

8. The method of claim 7, wherein the corrective value is associated with a system design for a plurality of network devices.

9. An apparatus, comprising:
a communication interface unit;
a first communication port through which the communication interface unit is to exchange information;
a second communication port through which the communication interface unit is to exchange information via a detachable attachment; and
a storage unit to store a corrective value to be used by the communication interface unit to adjust a signaling characteristic based on the presence of the attachment.

10. The apparatus of claim 9, wherein the attachment is a docking station.

11. The apparatus of claim 10, wherein the apparatus is associated with at least one of: (i) a mobile computer, (ii) a laptop computer, (iii) a hand-held computer, (iv) a personal digital assistant, (v) a game device, (vi) a media player, or (vii) a personal computer.

12. The apparatus of claim 9, wherein the first and second ports are both to facilitate communication via the same type of network.

13. The apparatus of claim 9, wherein the first communication port comprises an Ethernet RJ-45 port and the signaling characteristic is associated with compliance with the Institute of Electrical and Electronics Engineers 802.3 standard.

14. The apparatus of claim 13, wherein the communication interface unit comprises an Ethernet controller.

15. The apparatus of claim 14, further comprising:
a magnetic isolation module between the Ethernet controller and at least one of the first or second ports.

16. A method, comprising:
determining if a network device is currently attached to a detachable attachment, the network device having a first communication port and a second communication port, the second communication port being associated with the detachable attachment; and
adjusting a signaling characteristic of the network device based on the determination and a locally stored corrective value.

17. The method of claim 16, wherein the attachment is a docking station and said determining comprises receiving a signal when the docking station is attached.

18. The method of claim 17, wherein the corrective value is associated with an output waveform adjustment applied when the docking station is attached.

19. The method of claim 17, wherein the corrective value is associated with an output waveform adjustment applied when the docking station is not attached.

20. An apparatus comprising:
a storage medium having stored thereon instructions that when executed by a machine result in the following:
receiving at a mobile computer's Ethernet controller a signal indicating whether or not a docking station is currently attached to the mobile computer, the mobile computer having a first port and a second port, the second port being associated with the docking station, and
adjusting a signaling characteristic of the Ethernet controller based on the received signal and a locally stored corrective value.

21. The apparatus of claim 20, wherein said adjusting is associated with the Institute of Electrical and Electronics Engineers 802.3 standard.

22. The apparatus of claim 19, wherein the corrective value was determined during design of a system associated with the Ethernet controller.

23. A system, comprising:
a color display device;
a communication interface unit;
a first communication port through which the communication interface unit is to exchange information;
a second communication port through which the communication interface unit is to exchange information via a docking station; and
a storage unit to store a set of corrective values to be used by the communication interface unit to adjust a signaling characteristic based on the presence of the docking station.

24. The system of claim 23, wherein the communication interface unit is an Ethernet controller.

25. The system of claim 23, wherein the corrective value was determined during design of a portion of the system.
